(19) United States
(12) Patent Application Publication
(10) Pub. No.: US 2026/0125291 A1
(43) Pub. Date: May 7, 2026

(54) FLOATING OIL COLLECTING DEVICE

(71) Applicant: TBM CO., LTD., Saitama (JP)

(72) Inventor: Kunihiro SAHARA, Tokyo (JP)

(21) Appl. No.: 19/480,999

(22) PCT Filed: Nov. 14, 2023
(86) PCT No.: PCT/JP2023/040845

§ 371 Date: Nov. 3, 2025

(51) Int. Cl. C02F 1/40; B01D 17/02; C02F 101/32; C02F 103/32

(52) U.S. Cl. CPC C02F 1/40; B01D 17/0214; C02F 2101/32; C02F 2103/32

(57) ABSTRACT

A floating oil collecting device is provided for efficiently removing large amounts of oil from oil/water separation and adjustment tanks in food factories and similar facilities. The device maintains high collection efficiency even during long-term use. The device includes a swirl collection cup positioned beneath the water surface of the tank, tapering downward to an outlet at its base. A first pipe guides collected oil downward from the cup, a second pipe redirects flow horizontally, and a third pipe conveys the oil upward. The third pipe is mounted on a slider mechanism along the tank wall, enabling vertical movement. A buoyant element maintains a constant distance between the submerged swirl collection cup and the water surface, ensuring stable operation. This structure allows continuous, reliable collection of floating oil with minimal maintenance.

### CROSS-REFERENCE TO RELATED APPLICATION

This application is a national phase of International Application No. PCT/JP2023/040845 filed Nov. 14, 2023, the contents of which being incorporated by reference in its entirety herein.

### TECHNICAL FIELD

This disclosure relates to a floating oil collecting device for efficiently collecting floating oil, which accumulates in an oil/water separation tank or an adjustment tank, wherein the tank is placed in a food factory or the like that discharges oil-containing wastewater.

### BACKGROUND

Manufacturing wastewater from food factories and other sources contains various water pollutants (oil). If such wastewater is drained without any treatment, oil and other substances in the wastewater will stick to drain pipes and be solidified. This causes the drain pipes to become clogged. As a result, purifying water in combined treatment tanks and purifying water at sewage treatment plants become difficult. In addition, it may cause a negative impact on the environment, become subject to legal restrictions, and cause an inability to continue their business operations. Therefore, various methods and devices have been proposed for treating wastewater containing solids such as oil, sediment, and floating substances on a business facility basis.

Methods for collecting floating oil contained in wastewater can be broadly divided into (1) suction type and (2) adsorption type. (1) In terms of the suction type, for example, oil-containing wastewater is pooled in large tanks such as an oil/water separation tank, raw water tank, and adjustment tank. Then the large amount of floating oil and fats around the surface is physically sucked up and pumped out through a suction nozzle equipped with a float that responds to fluctuations in the liquid level. In addition, (2) in terms of the adsorption type, sheet or mat-shaped oil absorbents are placed in an oil/water separation tank, and the floating oil on the water surface is directly absorbed using these oil absorbents.

As for another floating oil collecting device, a floating oil collecting device that can improve the collecting efficiency of floating oil has been disclosed (for example, referring to Patent Document 1). Furthermore, an oil separation/management device that comprises a control device having an oil sensor and a data transmitting/receiving means, and efficiently recovers oil from oil-containing wastewater has also been disclosed (for example, referring to Patent Document 2). Furthermore, a simple device for efficiently purifying wastewater containing oil, solids, etc. has also been disclosed (for example, referring to Patent Document 3).

### CITATION LIST

### Patent Document

[Patent document 1] Japanese Unexamined Patent Application Publication No. 2020-032348

[Patent document 2] Publication of Japanese Utility Model Registration No.3216173

[Patent document 3] Publication of Japanese Patent Registration No.4420750

### BRIEF SUMMARY

However, the above-mentioned (1) suction type and (2) adsorption type for collecting floating oil have a fundamental problem in that it takes time to collect the floating oil. In particular, at sites such as large food factories where large amounts of floating oil are generated, the above-mentioned floating oil collecting methods are unable to collect all the floating oil, and the floating oil ends up accumulating gradually. As a result, odors may come from the wastewater (pool), and separation and removal of oil tend to be incomplete. In conclusion, large systems and equipment may be required, which requires a lot of costs.

In particular, since floating oil is made from animal and vegetable oils, the floating oil that accumulates in oil/water separation tank installed on-site at food factories is different from general cutting oil and other machine oils. This floating oil has a relatively high viscosity and tends to solidify. For this reason, when using conventional suction-type floating oil collecting methods, the oil that adheres to the area around the float and near the suction nozzle opening tends to harden and stick. Once this type of condition occurs, the adhering oil blocks the suction port, causing a problem that the efficiency of collecting the floating oil is further reduced.

Recently, the problem of global warming has become more and more serious. Despite efforts to reduce the emission of greenhouse gases such as carbon dioxide and methane, the impact of accumulated emissions continues to pose a significant challenge. At the same time, renewable energy made from recycled waste is getting more attention. Waste oil, which can be biomass resources, wasted from food factories, and so on, weighs more than one million tons in a year in Japan. If it is expanded to a global scale, the amount will be extremely huge. Recently, to produce original biomass fuels from waste oil, which used only to be wasted as industrial sludge, an original biomass fuel generation technology has been developed. With this fuel used as fuel for boilers and power generation, CO2 reduction, recycling, and water purification can be achieved. In other words, in order to promote decarbonization and resource circulation, there is an urgent need to establish a technology for efficiently collecting recyclable oil from waste oil discharged from food factories, and the like.

The present disclosure has been made in view of the above-mentioned problems and has an objective to provide a floating oil collecting device, that can efficiently collect large amounts of floating oil that accumulates in oil/water separation tanks and adjustment tanks at food factories and other facilities that discharge oil-containing wastewater, in a short period of time, and that can prevent the efficiency of collecting floating oil from decreasing even after long-term use.

In order to solve the abovementioned issues, the present disclosure is a floating oil collecting device for collecting floating oil that has accumulated in an oil/water separation tank, the floating oil collecting device comprising: a swirl collection cup that is disposed beneath the water surface side of the oil/water separation tank, and whose diameter tapers downward; a first pipe that is connected to the outlet, which is located at the bottom of the swirl collection cup, to guide the collected floating oil downward; a second pipe that is placed downstream of the first pipe and serves to guide the floating oil in the first pipe along a horizontal direction; a third pipe that is placed downstream of the second pipe and serves to guide the floating oil in the second pipe upward; a slider mechanism that is arranged along the inner wall of the oil/water separation tank and accommodates the third pipe so that the third pipe can slide vertically; and a buoyancy material that maintains a constant distance between the swirl collection cup, which is submerged in the oil/water separation tank, and the water surface.

In this floating oil collecting device, optionally, further comprising: a suction pump that efficiently sucks the floating oil from the swirl collection cup.

In this floating oil collecting device, optionally, wherein the suction pump is a self-priming pump or an air-driven pump, and wherein the self-priming pump or the air-driven pump is placed between the first pipe and the second pipe.

In this floating oil collecting device, optionally, wherein the suction pump is a self-priming pump or an air-driven pump, and wherein the self-priming pump or the air-driven pump is placed on the ground downstream from the third pipe.

In this floating oil collecting device, optionally, further comprising: a U-shaped pipe that is connected to the upper end of the third pipe; and a duct oil-resistant hose that is made of a flexible material, wherein one end of the duct oil-resistant hose is connected to the U-shaped pipe and the other end of the duct oil-resistant hose is connected to a pipe that guides the floating oil from the third pipe downstream.

In this floating oil collecting device, optionally, wherein the slider mechanism comprises: a pipe fixing duct that has a U-shape at the horizontal cross-section, and has an opening space extending along the vertical direction, and a plurality of rotating rollers that are arranged horizontally between the opposing surfaces of the pipe fixing duct and also arranged near the opening surface side of the pipe fixing duct, wherein the pipe fixing duct is fixed to the inner wall of the oil/water separation tank so that it extends vertically, an wherein the third pipe is disposed in the opening space inside the rotating rollers.

In this floating oil collecting device, optionally, further comprising: a fastener for engaging the third pipe; and a plate-shaped or rod-shaped anti-rotation member that is fixed to the third pipe using the fastener, wherein the anti-rotation member is arranged along the side wall of the oil/water separation tank.

In this floating oil collecting device, optionally, wherein the swirl collection cup comprises: a baffle plate that is erected at a predetermined height over a predetermined range of the upper edge of the swirl collection cup, which is circular in plane view; and a weight plate that is provided over a predetermined range of the upper edge opposite the baffle plate.

In order to solve the abovementioned issues, the present disclosure is a floating oil collecting device for collecting floating oil that has accumulated in an oil/water separation tank, the floating oil collecting device comprising: a swirl collection cup that is disposed beneath the water surface side of the oil/water separation tank, and whose diameter tapers downward; a first pipe that is connected to the outlet, which is located at the bottom of the swirl collection cup, to guide the collected floating oil downward; a second pipe that is placed downstream of the first pipe and serves to guide the floating oil in the first pipe along a horizontal direction; a third pipe that is placed downstream of the second pipe and serves to guide the floating oil in the second pipe upward; a coil tube that is interposed midway through the third pipe and is vertically extendable and contractible; and a buoyancy material that maintains a constant distance between the swirl collection cup, which is submerged in the oil/water separation tank, and the water surface.

In this floating oil collecting device, optionally, further comprising: a joint box that connects the third pipe and the coil tube, wherein the diameter of the third tube is different from the diameter of the coil tube.

The present disclosure is a floating oil collecting device for collecting floating oil that has accumulated in an oil/water separation tank, the floating oil collecting device comprises: a swirl collection cup that is disposed beneath the water surface side of the oil/water separation tank, and whose diameter tapers downward; a first pipe that is connected to the outlet, which is located at the bottom of the swirl collection cup, to guide the collected floating oil downward; a second pipe that is placed downstream of the first pipe and serves to guide the floating oil in the first pipe along a horizontal direction; a third pipe that is placed downstream of the second pipe and serves to guide the floating oil in the second pipe upward; a slider mechanism that is arranged along the inner wall of the oil/water separation tank and accommodates the third pipe so that the third pipe can slide vertically; and a buoyancy material that maintains a constant distance between the swirl collection cup, which is submerged in the oil/water separation tank, and the water surface. With this configuration, the floating oil collecting device according to this disclosure can efficiently collect large amounts of floating oil that accumulates in oil/water separation tanks and adjustment tanks at food factories and other facilities that discharge oil-containing wastewater, in a short period of time. In addition, the floating oil collecting device can prevent the efficiency of collecting floating oil from decreasing even after long-term use.

### BRIEF DESCRIPTION OF DRAWINGS

FIG. 1 is a diagram showing an example of a floating oil collecting device according to this embodiment of this disclosure.

FIG. 2 is a diagram showing an example of the floating oil collecting device.

FIG. 3a shows a state where the water surface level of the oil/water separation tank of the floating oil collecting device is lowered, and FIG. 3b shows a state where the water surface level of the oil/water separation tank of the floating oil collecting device is in a normal state.

FIG. 4a shows a state where the water surface level of the oil/water separation tank of the floating oil collecting device is at its standard state, and FIG. 4b shows a cross-sectional view along lines A-A.

FIG. 5 is an explanatory diagram of a slider mechanism equipped with the floating oil collecting device.

FIG. 6a is a plane view of the swirl collection cup equipped with the floating oil collecting device. FIG. 6b is a side view of the swirl collection cup. FIG. 6c is a side view of the swirl collection cup from a different angle. FIG. 6d is a diagram explaining the flow around the swirl collection cup.

FIG. 7 is a diagram showing an example of the configuration of a floating oil collecting device according to a variation of an embodiment of this disclosure.

FIG. 8 is a diagram showing an example of the configuration of a floating oil collecting device according to a variation of an embodiment of this disclosure.

FIG. 9a is a side view of a coil tube and a joint box equipped with the floating oil collecting device. FIG. 9b is a plane view of the coil tube and the joint box.

### DETAILED DESCRIPTION

### Embodiment

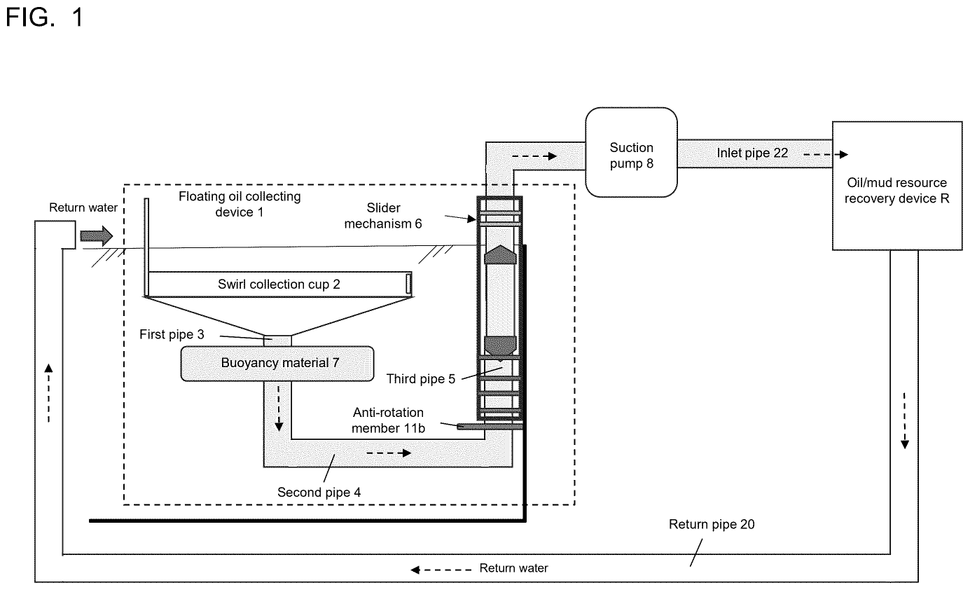

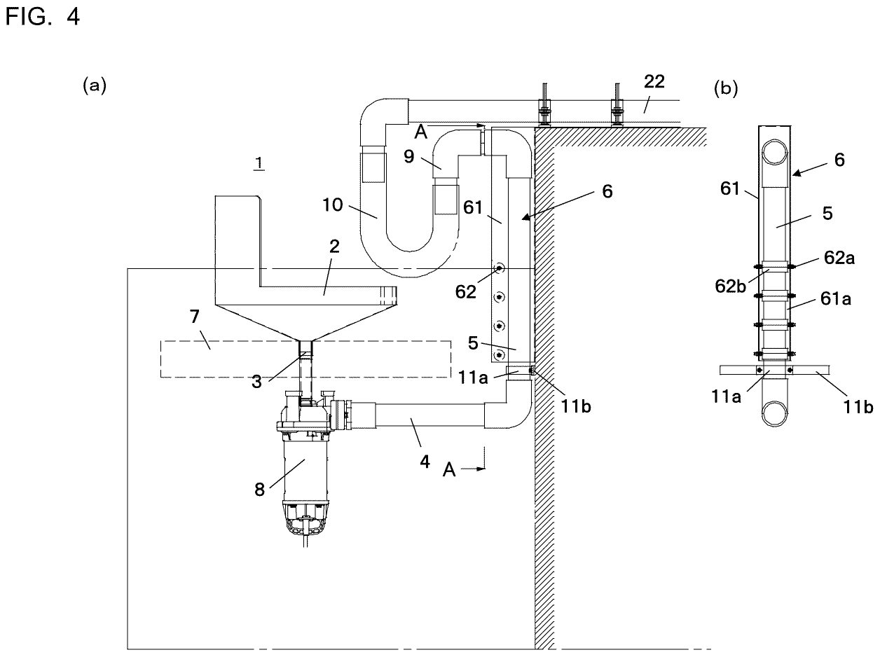

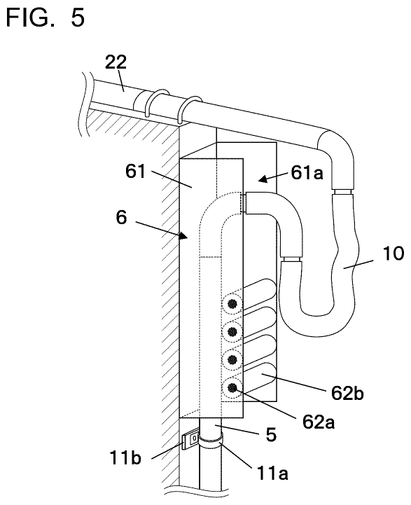

A floating oil collecting device according to an embodiment of the present disclosure will be explained with reference to FIGS. 1 to 6. This floating oil collecting device is a device for collecting a large amount of the upper layer (floating fats and oils, hereafter referred to as floating oil) that is floating in the oil/water separation tank (raw water tank, adjustment tank) and so on, wherein these tanks can pool manufacturing wastewater discharged from food factories, etc. The floating oil pumped out from the floating oil collecting device is temporarily stored in an oil/mud resource recovery device. Then, the oil and sludge are efficiently separated from the collected floating oil, and the water remaining after separation is returned to the oil/water separation tank as inflow water (return water). These devices are basically installed on-site at food factories and other facilities that discharge manufacturing wastewater.

First, the basic structure of the floating oil collecting device according to the present embodiment will be described with reference to FIG. 1. As shown in FIG. 1, the floating oil collecting device 1 is a device for collecting floating oil (oil-containing wastewater) that has accumulated in an oil/water separation tank T, and is comprised of a swirl collection cup 2, a first pipe 3, a second pipe 4, a third pipe 5, a slider mechanism 6 and a buoyancy material 7. The device 1 is used in a submerged state in the oil-water separation tank T. The oil/water separation tank T is also sometimes called a grease trap, oil trap, grease interceptor, etc., and its basic structure is generally a natural separation flotation method that utilizes the difference in specific gravity between water and oil.

The swirl collection cup 2 is disposed beneath the water surface side of the oil/water separation tank T and has the same bowl shape as a deep suction nozzle, wherein the diameter of the swirl collection cup 2 tapers downward (tapered). This swirl collection cup has a relatively large diameter, for example, of about 300 to 700 mm, and sucks up a large amount of floating oil at once in a swirling manner.

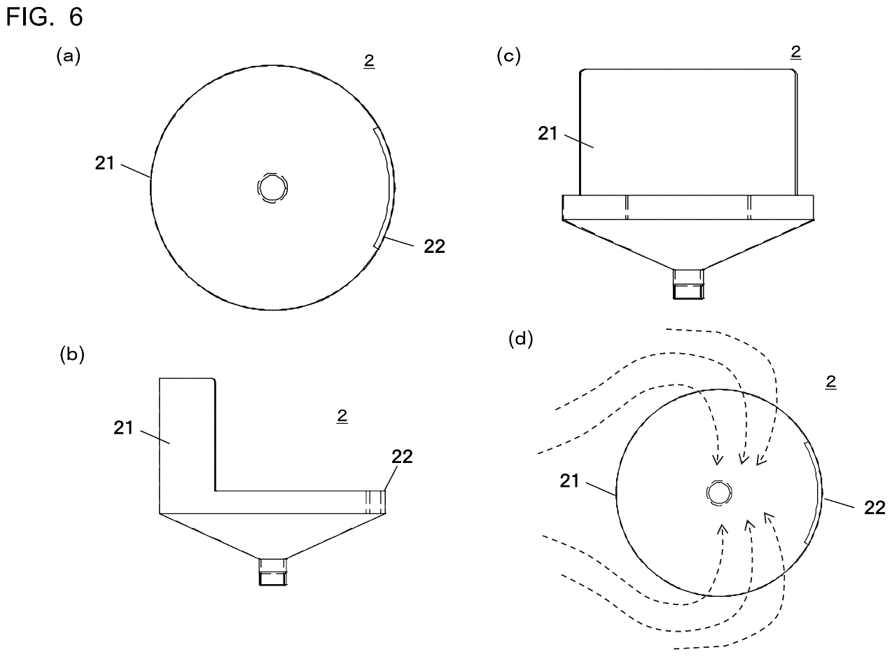

Herein, as shown in FIG. 6(a) to 6(c), the swirl collection cup 2 has a baffle plate 21 that is erected at a predetermined height (e.g., 250 mm) over a predetermined range (e.g., a range of 120 to 180 degrees) of the upper edge of the cup 2, which is circular in plane view, and a weight plate (SUS plate) 22 that is approximately the same weight as the baffle plate 21 and is provided over a predetermined range of the upper edge opposite from the baffle plate 21. The baffle plate 21 and the weight plate 22 may be welded to the swirl collection cup 2. With this configuration of the weight plate 22, it can prevent only the baffle plate 21 side of the swirl collection cup 2 from becoming heavy and tilting. As a result, the swirl collection cup 2 can always be kept horizontal.

Herein, a method for collecting the floating oil using the swirl collection cup 2 will be described. When the return water from the oil/mud resource recovery device R is forcefully discharged onto the water surface of the oil/water separation tank T via the return pipe 20, a flow in a predetermined direction is generated on the water surface, causing the floating oil to move. In this case, as shown by the arrow in FIG. 6 (d), the floating oil hits the baffle plate 21 of the swirl collection cup 2 and swirls, and the oil-containing wastewater (floating oil) with a high (floating) waste oil content circulates around the baffle plate 21 and is efficiently sucked in through the suction port of the swirl collection cup 2. As a result of this, the floating oil is efficiently collected in the swirl collection cup 2 and guided to the oil/mud resource recovery device R via the first pipe 3 to the third pipe 5.

The first pipe 3 is, for example, a PVC pipe having a diameter of about 25 mm, and is connected to the outlet at the bottom of the swirl collection cup 2 to guide the floating oil collected by the swirl collection cup 2 downward.

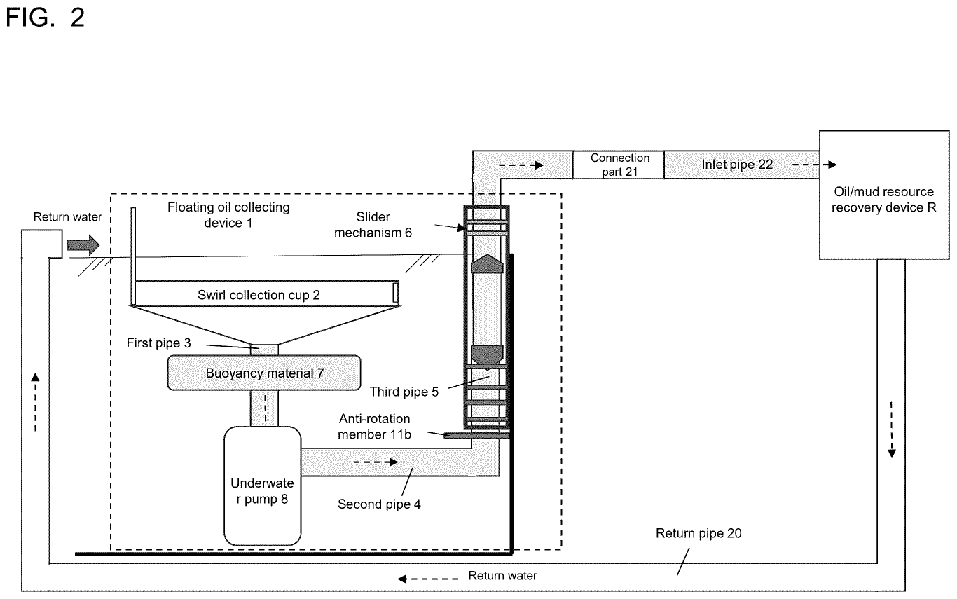

The second pipe 4 is located downstream of the first pipe 3 and serves to guide the floating oil in the first pipe 3 along a horizontal direction and is made of, for example, a PVC pipe having a diameter of about 50 mm. As shown in FIG. 2, a suction pump 8 is provided between the first pipe 3 and the second pipe 4 to efficiently suck the floating oil from the swirl collection cup 2. Specifically, the suction pump 8 is an underwater pump 8 that is used with its body submerged upside down in the oil/water separation tank T and is equipped with a motor for creating a water flow. The underwater pump 8 has a suction port on the suction side. The suction port is connected to the first pipe 3, and a discharge port of the underwater pump 8 is connected to the second pipe 4. The weight of the underwater pump 8 is, for example, about 8 kg. In addition, instead of the underwater pump 8, an air-driven pump may be used, wherein said pump creates compressed air using an air compressor and utilizes the expanding force of the compressed air.

Herein, the depth of the oil/water separation tank T is usually 1 m or more, and the height of the floating oil collecting device 1 is 700 mm in total, consisting of the distance 50 mm from the water surface to the upper edge of the swirl collection cup 2, the height 150 mm of the swirl collection cup 2, the height 100 mm of the buoyancy material 7, and the height 400 mm of the underwater pump 8. Therefore, the floating oil collecting device 1 can maintain a floating state in the oil/water separation tank T.

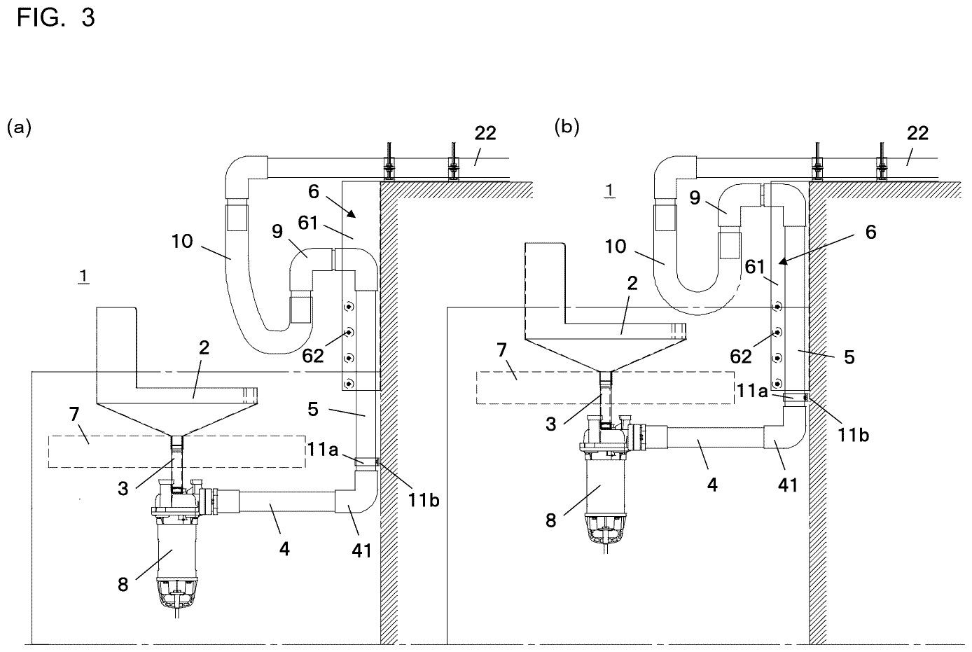

The third pipe 5 is placed downstream of the second pipe 4 and serves to guide the floating oil in the second pipe 4 upward and is made of, for example, a PVC pipe having a diameter of about 50 mm. By setting the diameters of the second pipe 4 and the third pipe 5 to about 50 mm, it is possible to prevent foreign objects contained in the sucked floating oil from clogging the pipes and causing problems. In this embodiment, as shown in FIG. 3, the second pipe 4 and the third pipe 5 are screwed together (jointed) via an L-shaped pipe 41 so as to form a right angle.

The slider mechanism 6 is fixed and arranged along the inner wall of the oil/water separation tank T and accommodates the third pipe 5 so that the third pipe 5 can slide vertically. In order to describe the slider mechanism 6 in detail, the slider mechanism 6 has a U-shape at the horizontal cross-section as shown in FIGS. 3 to 5. The slider mechanism 6 comprises a pipe fixing duct 61 having a slit-shaped opening space 61a extending along the vertical direction, and a plurality of rotating rollers 62 arranged horizontally between the opposing surfaces of the pipe fixing duct 61 and also arranged near the opening surface side of the pipe fixing duct 61. As shown in FIG. 3, the bottom of the pipe fixing duct 61 is fixed to the inner wall of the oil/water separation tank T using anchor bolts so that it extends vertically. The pipe fixing duct 61 is made of a relatively strong metal such as SUS. The rotating roller 62 is composed of, for example, a shaft 62a fixed to the pipe fixing duct 61 and a rotatable resin pipe 62b. The third pipe 5 is disposed in the opening space 61a inside the rotating rollers 62. This slider mechanism 6 allows the floating oil collecting device 1 to move up and down in accordance with the height of the water surface in the oil/water separation tank T, and always maintain a constant distance from the water surface.

Furthermore, as shown in FIGS. 3 to 5, the floating oil collecting device 1 comprises a U-shaped pipe 9 connected to the upper end of the third pipe 5, and a duct oil-resistant hose 10 made of a flexible (soft, elastic) material, wherein one end of the duct oil-resistant hose 10 is connected to the U-shaped pipe 9 and the other end of the duct oil-resistant hose 10 is connected to an inlet pipe 22 that guides the floating oil from the third pipe 5 downstream. The U-shaped pipe 9 may be formed by connecting two L-shaped pipes as long as it has a U-shape. The duct oil-resistant hose 10 is, for example, a PVC pipe (HT50A) with a diameter of 50 mm, and needs to be slackened at an optimal length so that the hose 10 can expand when the water surface level drops and relaxes when the water level rises. In other words, the duct oil-resistant hose 10 has a length that allows it to relax moderately without stretching completely even when the swirl collection cup 2 is lowered to the deepest.

For example, in a case when the standard is to accommodate a vertical difference of within 200 mm, FIG. 3(a) shows a state in which the floating oil has been collected and the water surface level in the oil/water separation tank T has dropped by 200 mm, while FIG. 3(b) shows a state in which the oil-containing wastewater has flowed in the oil/water separation tank T and the water surface level is at its normal position. As shown in this figure, the duct oil-resistant hose 10 can always be kept at a constant distance from the water surface.

The floating oil, which has passed through the duct oil-resistant hose 10, is introduced into the oil/mud resource recovery device R (oil and sludge collecting tank) via the connection part 21 and the inlet pipe 22 as shown in FIG. 2, wherein the device R temporarily stores the upper layer of the oil/water separation tank T and collects the oil and sludge. Furthermore, due to the connection part 21, the floating oil collecting device 1 can be easily separated from the main device pipe when conducting the maintenance of the floating oil collecting device 1.

In terms of the oil/mud resource recovery device R, oil and water are separated according to their specific gravities, with the floating oil forming the upper layer and the inflow water forming the lower layer. This inflow water is circulated and collected to the oil/water separation tank T via the return pipe 20. As a result, in terms of the oil/mud resource recovery device R, the oil, sludge, and water are separated from the oil-containing wastewater collected using the floating oil collecting device 1, and the oil is efficiently extracted, collected and recycled.

The buoyancy material 7 is a float plate that maintains a constant distance between the swirl collection cup 2, which is submerged in the oil/water separation tank T, and the water surface. The buoyancy material 7 is formed of a material having a buoyancy such that the weight of the swirl collection cup 2 does not cause it to sink into the waste oil layer of the oil/water separation tank T. The material is for example polystyrene foam. The swirl collection cup 2 weighs, for example, about 5 kg, the underwater pump 8 weighs about 8 kg, and the weight of the entire floating oil collecting device 1 is constant at about 15 kg. The buoyancy of the buoyancy material 7 can be adjusted by adjusting the number and thickness of the material so that the suction surface (upper surface) of the swirl collection cup 2 is kept submerged, for example, by 50 mm below the water surface in the oil/water separation tank T. This distance is adjusted according to the viscosity of the floating oil to be collected, i.e., the distance is short for floating oil with high viscosity and long for floating oil with low viscosity.

Furthermore, as shown in FIG. 3, the floating oil collecting device 1 comprises a fastener 11a such as a U-shaped screw for engaging the third pipe 5, and a plate-shaped or rod-shaped anti-rotation member 11b fixed to the third pipe 5 using the fastener 11a. The longitudinal direction of this anti-rotation member 11b is arranged along the side wall of the oil/water separation tank T. At the same time, the anti-rotation member 11b is arranged but separated from the side wall, thereby preventing the third pipe 5 from rotating or twisting. As a result, the swirl collection cup 2 is prevented from shifting forward, backward, left, or right, and has the function of keeping its orientation in a fixed direction.

As mentioned above, the floating oil collecting device 1 for collecting floating oil that has accumulated in an oil/water separation tank T, the floating oil collecting device 1 comprises: a swirl collection cup 2 that is disposed beneath the water surface side of the oil/water separation tank T, and whose diameter tapers downward; a first pipe 3 that is connected to the outlet, which is located at the bottom of the swirl collection cup 2, to guide the collected floating oil downward; a second pipe 4 that is placed downstream of the first pipe 3 and serves to guide the floating oil in the first pipe 3 along a horizontal direction; a third pipe 5 that is placed downstream of the second pipe 4 and serves to guide the floating oil in the second pipe 4 upward; a slider mechanism 6 that is arranged along the inner wall of the oil/water separation tank T and accommodates the third pipe 5 so that the third pipe 5 can slide vertically; and a buoyancy material 7 that maintains a constant distance between the swirl collection cup 2, which is submerged in the oil/water separation tank T, and the water surface. With this configuration, this disclosure can efficiently collect large amounts of floating oil that accumulates in oil/water separation tanks and adjustment tanks at food factories and other facilities that discharge oil-containing wastewater, in a short period of time. Also, this disclosure can prevent the efficiency of collecting floating oil from decreasing even after long-term use.

The floating oil wasted from food factories has the characteristic that it is highly viscous and tends to solidify because of animal and vegetable oil. However, in a state where the oil flows into the oil/water separation tank T or the adjustment tank and then the oil floats up, it is still sufficiently liquid. If it is collected in a short period of time at this timing, the floating oil can be collected easily and most efficiently. The floating oil collecting device 1 according to the present disclosure has solved this problem. In fact, in a floating oil collecting test using the “Vortex Recovery Cup 2” at Toyo Suisan's Hidaka Factory, more than 100 liters of floating oil was collected in one go in just 15 minutes of the operation.

In addition, in recent years, some food factories, unlike restaurants, have been producing several tons of floating grease every day. Therefore, the floating oil collecting device 1 such as that of the present disclosure can be installed in the oil/water separation tank T on the factory premises, and a service can be provided in which reusable oil is extracted from the collected oil-containing wastewater and recycled on-site. In other words, there is no doubt that the floating oil collecting device 1 of the present disclosure can be effectively utilized to realize a carbon-free society.

### Variation 1

The floating oil collecting device according to the variation 1 of the present embodiment will be explained. In this variation 1, as shown in FIG. 1, the suction pump 8 is a self-priming pump or an air-driven pump and is placed on the ground downstream from the third pipe 5. In this case, compared to the above embodiment, the underwater weight is lighter, so the buoyancy material 7 can be made thinner. Since an underwater pump is no longer necessary, the height of the floating oil collecting device 1 can be significantly reduced to, for example, 300 mm. As a result, it can be installed in a relatively shallow oil/water separation tank T.

### Variation 2

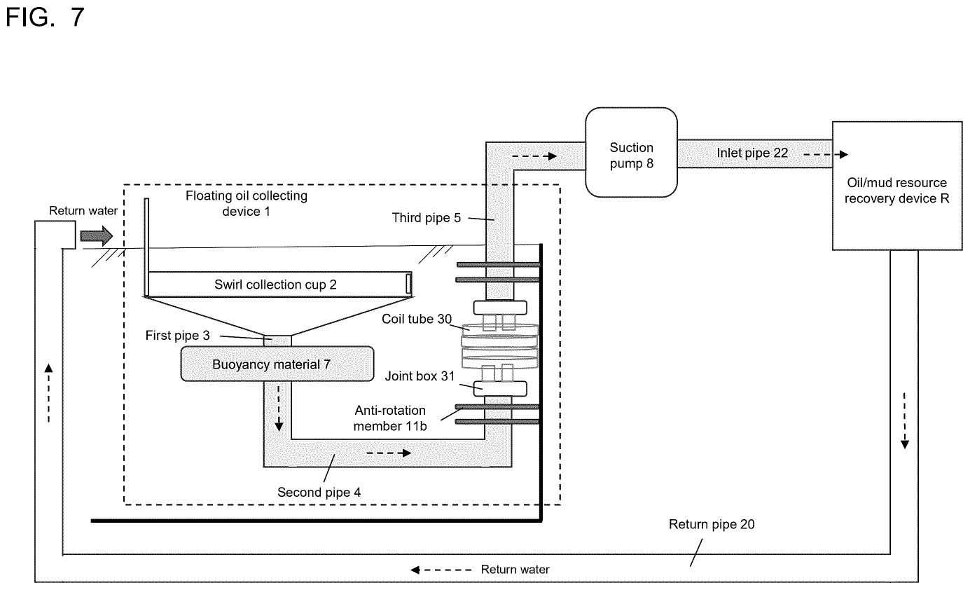

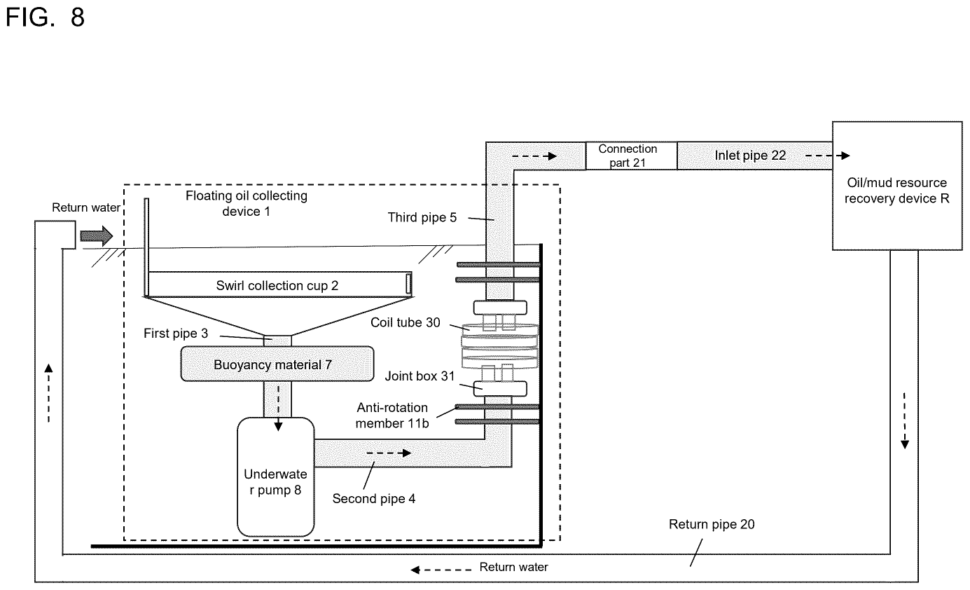

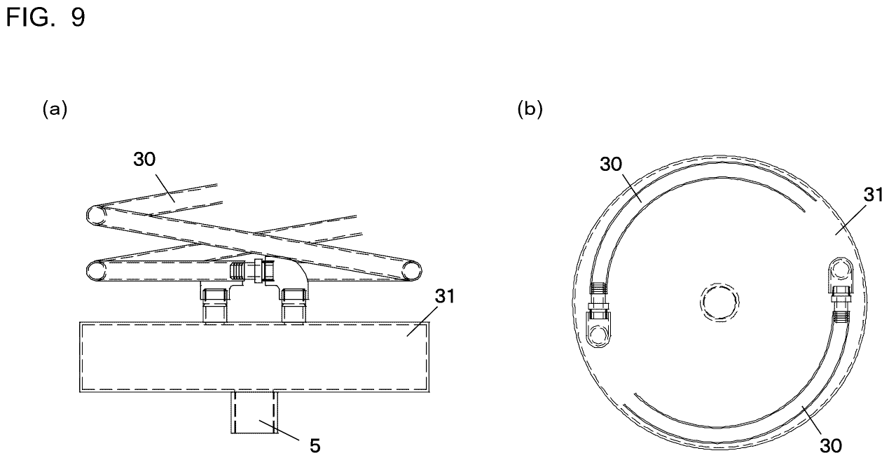

The floating oil collecting device according to the variation 2 of the present embodiment will be explained with reference to FIGS. 7 to 9. In this variation 2, instead of the slider mechanism 6 described above, a coil tube 30 is interposed midway through the third pipe 5 and is vertically extendable and contractible. The coil tube 30 has a spiral shape and is expandable and contractable along the vertical direction. Also, a joint box 31 is provided to connect the third pipe 5 and the coil tube 30. As shown in FIG. 9, this joint box 31 joints the third pipe 5 having a diameter of, for example, 50 mm to the coil tube 30 having smaller diameters (for example, 25 mm+25 mm).

It is noted that the present disclosure is not limited to the above-described embodiments and modified examples, and various modifications are possible within the spirit and scope of the present disclosure. For example, in addition to the underwater pump 8, a dedicated underwater pump may be provided to create a flow on the water surface of the oil/water separation tank T in order to increase the collection efficiency of the swirl collection cup 2.

### REFERENCE SIGNS LIST

1 Floating oil collecting device
2 Swirl collection cup
3 First pipe
4 Second pipe
5 Third pipe
6 Slider mechanism
7 Buoyancy material
8 Suction pump (underwater pump, air-driven pump, self-priming pump)
9 U-shaped pipe
10 Duct oil-resistant hose
11a Fastener
11b Anti-rotation member
30 Coil tube
31 Joint box
61 Pipe fixing duct
61a Opening space
62 Rotating roller

1-10. (canceled)

11. A floating oil collecting device for collecting floating oil that has accumulated in an oil/water separation tank, the floating oil collecting device comprising:
a swirl collection cup that is disposed beneath the water surface side of the oil/water separation tank, and whose diameter tapers downward;
a first pipe that is connected to the outlet, which is located at the bottom of the swirl collection cup, to guide the collected floating oil downward;
a second pipe that is placed downstream of the first pipe and serves to guide the floating oil in the first pipe along a horizontal direction;
a third pipe that is placed downstream of the second pipe and serves to guide the floating oil in the second pipe upward;
a slider mechanism that is arranged along the inner wall of the oil/water separation tank and accommodates the third pipe so that the third pipe can slide vertically; and
a buoyancy material that maintains a constant distance between the swirl collection cup, which is submerged in the oil/water separation tank, and the water surface,
wherein the slider mechanism comprises:
a pipe fixing duct that has a U-shape at the horizontal cross-section, and has an opening space extending along the vertical direction, and
a plurality of rotating rollers that are arranged horizontally between the opposing surfaces of the pipe fixing duct and also arranged near the opening surface side of the pipe fixing duct,
wherein the pipe fixing duct is fixed to the inner wall of the oil/water separation tank so that it extends vertically, and
wherein the third pipe is disposed in the opening space inside the rotating rollers.

12. The floating oil collecting device according to claim 11, further comprising:
a suction pump that efficiently sucks the floating oil from the swirl collection cup.

13. The floating oil collecting device according to claim 12, wherein the suction pump is a self-priming pump or an air-driven pump, and wherein the self-priming pump or the air-driven pump is placed between the first pipe and the second pipe.

14. The floating oil collecting device according to claim 12, wherein the suction pump is a self-priming pump or an air-driven pump, and wherein the self-priming pump or the air-driven pump is placed on the ground downstream from the third pipe.

15. The floating oil collecting device according to claim 11, further comprising:
a U-shaped pipe that is connected to the upper end of the third pipe; and
a duct oil-resistant hose that is made of a flexible material, wherein one end of the duct oil-resistant hose is connected to the U-shaped pipe and the other end of the duct oil-resistant hose is connected to a pipe that guides the floating oil from the third pipe downstream.

16. The floating oil collecting device according to claim 11, further comprising:
a fastener for engaging the third pipe; and
a plate-shaped or rod-shaped anti-rotation member that is fixed to the third pipe using the fastener,
wherein the anti-rotation member is arranged along the side wall of the oil/water separation tank.

17. The floating oil collecting device according to claim 11, wherein the swirl collection cup comprises:
a baffle plate that is erected at a predetermined height over a predetermined range of the upper edge of the swirl collection cup, which is circular in plane view; and
a weight plate that is provided over a predetermined range of the upper edge opposite the baffle plate.

18. A floating oil collecting device for collecting floating oil that has accumulated in an oil/water separation tank, the floating oil collecting device comprising:
a swirl collection cup that is disposed beneath the water surface side of the oil/water separation tank, and whose diameter tapers downward;
a first pipe that is connected to the outlet, which is located at the bottom of the swirl collection cup, to guide the collected floating oil downward;
a second pipe that is placed downstream of the first pipe and serves to guide the floating oil in the first pipe along a horizontal direction;
a third pipe that is placed downstream of the second pipe and serves to guide the floating oil in the second pipe upward;
a coil tube that is interposed midway through the third pipe and is vertically extendable and contractible; and
a buoyancy material that maintains a constant distance between the swirl collection cup, which is submerged in the oil/water separation tank, and the water surface,
wherein the floating oil collecting device, further comprising:
a joint box that connects the third pipe and the coil tube, wherein the diameter of the third tube is different from the diameter of the coil tube.
